(19) United States
(12) Patent Application Publication
(10) Pub. No.: US 2005/0219154 A1
(43) Pub. Date: Oct. 6, 2005

(54) Method of driving display panel

(76) Inventor: Hideto Nakamura, Yamanashi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/084,006

(22) Filed: Mar. 21, 2005

(30) Foreign Application Priority Data
Mar. 22, 2004 (JP) 2004-083107

(51) Int. Cl. G09G 3/28

(52) U.S. Cl. 345/60

(57) ABSTRACT

Disclosed is a method of driving a display panel capable of displaying an image with high contrast and high quality. In this method, a first reset discharge is triggered between one and the other row electrodes of a pair of row electrodes by applying a first reset pulse having a voltage increasing in magnitude with time to row electrodes to thereby form the wall charge, followed by triggering a second reset discharge between one and the other row electrodes of the pair of row electrodes by applying a second reset pulse having a pulse voltage lower in magnitude than that of a sustain pulse to the row electrodes to thereby adjust the amount of the wall charge.

### BACKGROUND OF THE INVENTION

1. Field of the Invention

The present invention relates to a method of driving a display panel which displays an image.

2. Description of the Related Art

AC-type (AC discharge type) plasma display panels have recently been commercialized as flat panel display devices. In plasma display panels, each discharge cell corresponding to a pixel emits light by using a discharge phenomenon, and therefore has only the two states: a light-emission state corresponding to a maximum luminescence level; and a non-emission state corresponding to a minimum luminescence level. In order to attain halftone or grayscale display levels according to an input image signal, gradation driving using a subfield method is implemented in such a plasma display panel.

In the gradation driving in accordance with the subfield method, a display driving for an image signal of one field is implemented in each of a plurality of subfields to which the number of light emissions to be carried out is assigned. In this case, an address step and a sustain step are sequentially carried out in each of the subfields. In the address step, a selective discharge is selectively triggered in accordance with an input image signal in each of the discharge cells, forming a predetermined amount of wall charge in each of the discharge cells (or erasing wall charge from each of the discharge cells). In the sustain step, a sustain discharge is repeatedly triggered only in discharge cells in which a predetermined amount of the wall charge is formed, by repeatedly applying sustain pulses, thereby continuing the light-emission state in response to the sustain discharges. Further, a step of initializing an amount of wall charge remaining in discharge cells (forming a predetermined amount of wall charge or erasing the wall charge) is carried out at least in the first subfield to generate a reset discharge in all discharge cells by applying reset pulses.

However, the abovementioned reset discharge is not related to content of an image to be displayed, and therefore the light emission in response to the reset discharge deteriorates the contrast of the image. In this regard, a driving method is suggested in which a reset discharge is weakened by gradually increasing a voltage level during the rise period of a reset pulse which is applied for generating the reset discharge in all discharge cells to cause the emission luminance in response to the reset discharge to be lowered (see FIG. 6 of Japanese Patent Kokai No. 2002-351394). The weakening of the reset discharge may result in variations in the amount of the wall charge formed in each discharge cell, causing a possible erroneous discharge as the selective discharge in the address step. In this regard, Japanese Patent Kokai No. 2002-351394 discloses a driving method in which the amount of wall charge is adjusted to a predetermined amount by applying a second reset pulse (RP₂) having the same pulse voltage (Vs) as that of the sustain pulse to generate a second reset discharge after the completion of the foregoing reset discharge.

However, according to the driving method mentioned above, image contrast is still lowered because of the light emission responding to the newly provided second reset discharge, and thus an effect of enhancing the image contrast obtained by weakening the first reset discharge is found to be reduced by one half.

### SUMMARY OF THE INVENTION

The present invention is provided to solve the above problems. It is an objection of the present invention to provide a method for driving a display panel capable of displaying an image with high contrast and high quality.

According to one aspect of the present invention, there is provided a method of driving a display panel in which display cells serving as pixels are formed at intersections of pairs of row electrodes corresponding to respective display lines with a plurality of column electrodes being arranged so as to intersect with the pairs of row electrodes. The method comprises the steps of: resetting by initializing an amount of wall charge in each of the display cells; selectively generating an address discharge in the display cells by applying a data pulse corresponding to an input image signal to each of the column electrodes while applying a scanning pulse to one row electrode of the pair of row electrodes to thereby form or erase the wall charge; and generating a sustain discharge only in the display cells in which the wall charge is formed, by applying sustain pulses alternately to one and the other row electrodes of the pair of row electrodes. The step of resetting includes the steps of: triggering a first reset discharge between one and the other row electrodes of the pair of row electrodes by applying a first reset pulse having a voltage increasing in magnitude with time to the row electrodes to thereby form the wall charge, and triggering a second reset discharge between one and the other row electrodes of the pair of row electrodes by applying a second reset pulse having a pulse voltage lower in magnitude than that of the sustain pulse to the row electrodes to thereby adjust the amount of the wall charge.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram illustrating the configuration of a display device in which a driving method of the present invention is applied;

FIG. 2 is a circuit diagram illustrating the specific configuration of each row electrode drive circuit for a display cell CS; and

FIG. 3 is a time chart illustrating the operation of each element in the circuits illustrated in FIG. 2.

### DETAILED DESCRIPTION OF THE INVENTION

In the present invention, a first reset discharge is triggered between one and the other row electrodes constituting a pair of row electrodes by the application of a first reset pulse having a voltage increasing in magnitude with time to the row electrodes to generate wall charge in a display cell, followed by triggering a second reset discharge between the row electrodes of the pair by the application of a second reset pulse having a pulse voltage lower in magnitude than a sustain pulse voltage to the row electrodes, thereby adjusting the amount of the wall charge in the display cell.

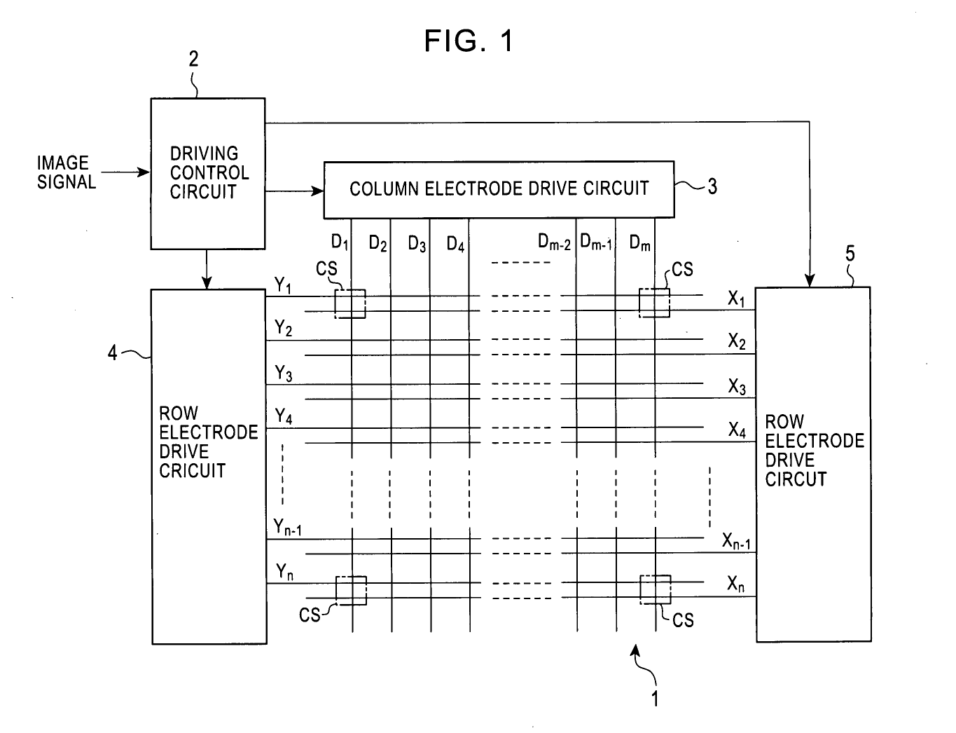

FIG. 1 illustrates the schematic configuration of a plasma display device in which the gradation driving of the plasma display panel in accordance with the driving method of the present invention is implemented.

Referring to FIG. 1, a plasma display panel or a PDP 1 comprises a transparent front substrate and a rear substrate which are not shown in the drawings. In the transparent front substrate, n row electrodes X₁ to Xₙ and n row electrodes Y₁ to Yₙ are arranged in an XY alternating manner. In the rear substrate, m column electrodes D₁ to Dₘ serving as an address electrode are formed. In the PDP 1, a pair of row electrodes (X, Y) adjacent to each other constitutes one display line of the PDP 1. That is, a first to n-th display lines are constituted by the row electrodes X₁ to Xₙ and the row electrodes Y₁ to Yₙ, respectively. A discharge space filled with a discharge gas is formed between the transparent front substrate and the rear substrate, and a display cell CS serving as a pixel is constructed at the intersection, including the discharge space, of each row electrode pair and each column electrode.

A driving control circuit 2 generates various timing signals for the gradation driving of the PDP 1 in accordance with the subfield method, and supplies the timing signals to row electrode drive circuits 4 and 5. The driving control circuit 2 also generates pixel data bits DB by dividing the pixel data of each pixel based on an input image signal for each bit digit, and supplies the pixel data bits DB for every display line (DB₁ to DBₘ) to a column electrode drive circuit 3.

The column electrode drive circuit 3 generates m pixel data pulses, each corresponding to the logical level of each of the pixel data bits DB₁ to DBₘ, and applies the pixel data pulses to the relevant column electrodes D₁ to Dₘ of the PDP 1.

The row electrode drive circuits 4 and 5 generate various driving pulses in response to various timing signals supplied from the driving control circuit 2, and applies the driving pulses to the row electrodes Y₁ to Yₙ and X₁ to Xₙ of the PDP 1. In the gradation driving in accordance with the subfield method, one field period of an input image signal is divided into a plurality of subfields, and a light emission driving for each display cell is implemented in each of the subfields.

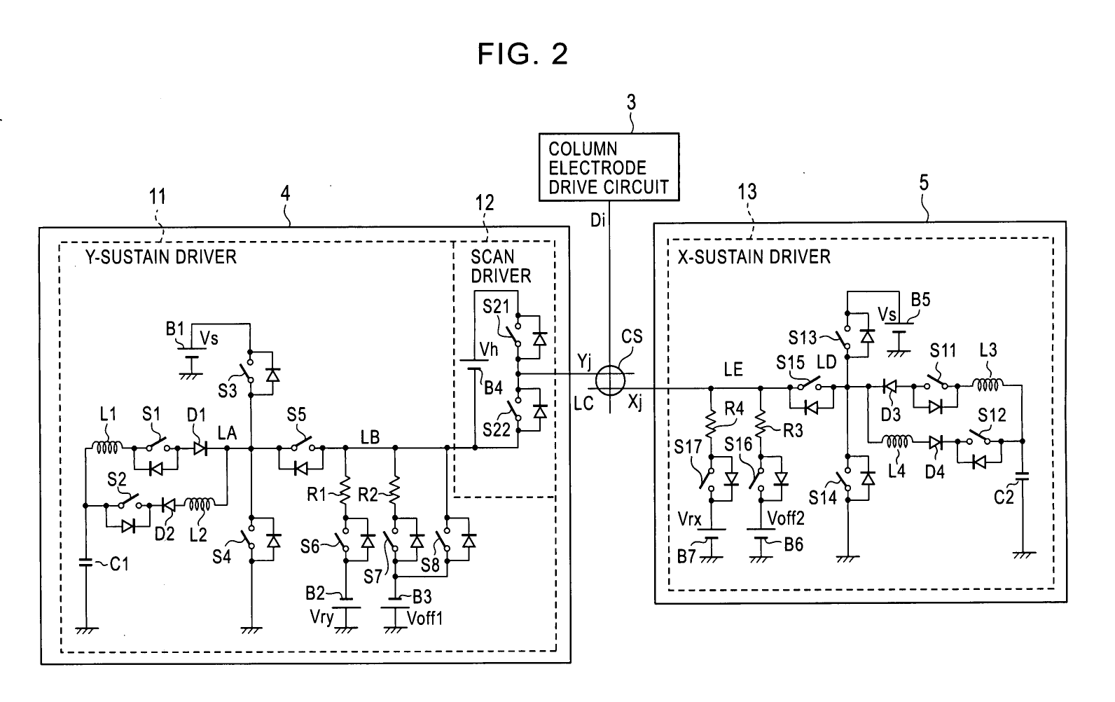

FIG. 2 illustrates the internal configuration of the row electrode drive circuits 4 and 5.

The row electrode drive circuit 4 comprises a Y-sustain driver 11 and a scan driver 12. The row electrode drive circuit 5 comprises an X-sustain driver 13.

The Y-sustain driver 11 comprises coils L1 and L2, switching elements S1 to S8, diodes D1 and D2, resistors R1 and R2, a capacitor C1, and power sources B1 to B3. The scan driver 12 comprises switching elements S21 and S22, and a power source B4. The X-sustain driver 13 comprises coils L3 and L4, switching elements S11 to S17, diodes D3 and D4, resistors R3 and R4, a capacitor C2, and power sources B5 to B7. The switching elements S1 to S8, S11 to S17, S21 and S22 comprise a parasitic diode indicated by a diode symbol in FIG. 2.

In the Y-sustain driver 11, the positive terminal of the power source B1 is connected to a connection line LA through the switching element S3, and the negative terminal thereof is connected to the ground. The power source B3 supplies a voltage Vs (for example, 200 V). The switching element S4 is connected between the connection line LA and the ground. Also, a series circuit comprising the diode D1, the switching element S1, and the coil L1 and another series circuit comprising the coil L2, the diode D2, and the switching element S2 are connected to the connection line LA, and the both series circuits are connected to the ground commonly though the capacitor C1. The anode of the diode D1 is connected to the connection line in the direction of the capacitor C1, and the cathode of the diode D2 is connected to the connection line in the direction of the capacitor C1. The connection line LA is connected, through the switching element S5, to a connection line LB which provides a connection to the negative terminal of the power source B4 of the scan driver 12. The negative terminal of the power source B2 is connected to the connection line LB through the switching element S6 and the resistor R1, and the positive terminal thereof is connected to the ground. Similarly, the negative terminal of the power source B3 is connected to the connection line LB through the switching element S7 and the resistor R2, and the positive terminal thereof is connected to the ground. The negative terminal of the power source B3 is also connected to the connection line LB only through the switching element S8. The power source B2 outputs a voltage Vry (for example, 100 V), and the power source B3 outputs a voltage Voff1 (for example, 100 V). The power source B4 outputs a voltage Vh (for example, 130 V, Vh<Vs). The on/off control of each of the above switching elements S1 to S8 is carried out in response to a timing signal output from the driving control circuit 2.

In the scan driver 12, the positive terminal of the power source B4 is connected, through the switching element S21, to a connection line LC which provides a connection to the row electrode Yⱼ, and the negative terminal of the power source B4, which is connected to a connection line LB, is connected to a connection line LC through the switching element S22. The on/off control of each of the above switching elements S21 and S22 is carried out in response to a timing signal output from the driving control circuit 2.

In the X-sustain driver 13, the positive terminal of the power source B5 is connected to a connection line LD through the switching element S13, and the negative terminal thereof is connected to the ground. The power source B5 outputs a voltage Vs (for example, 200 V). The switching element S14 is connected between the connection line LD and the ground. Also, a series circuit comprising the diode D3, the switching element S11, and the coil L3 and another series circuit comprising the coil L4, the diode D4, and the switching element S12 are connected to the connection line LD, and the both series circuits are connected to the ground commonly through the capacitor C2. The anode of the diode D3 is connected to the connection line in the direction of the capacitor C2, and the cathode of the diode D4 is connected to the connection line in the direction of the capacitor C2. The connection line LD is connected, through the switching element S15, to a connection line LE which provides a connection to the row electrode Xⱼ. The positive terminal of the power source B6 is connected to the connection line LE through the switching element S16 and the resistor R3, and the negative terminal thereof is connected to the ground. Similarly, the positive terminal of the power source B7 is connected to the connection line LE through the switching element S17 and the resistor R4, and the negative terminal thereof is connected to the ground. The power source B6 outputs a voltage Voff2 (for example, 100 V), and the power source B7 outputs a voltage Vrx (for example, 600 V). The on/off control of each of the above switching elements S11 to S17 is carried out in response to a timing signal output from the driving control circuit 2.

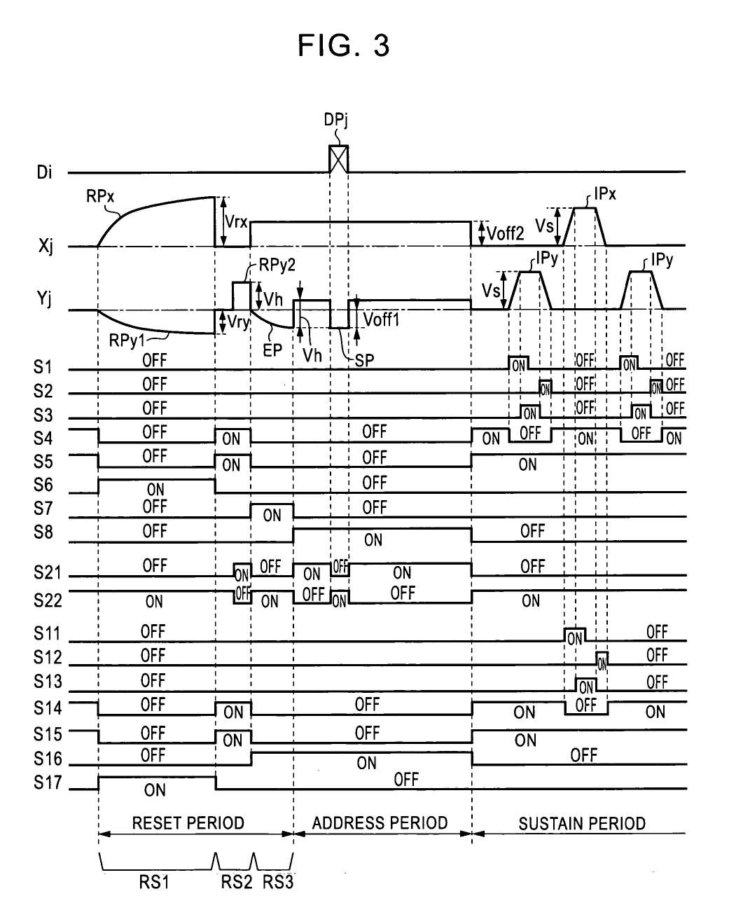

The operation of the aforementioned plasma display device will now be described with reference to a time chart illustrated in FIG. 3.

The time chart of in FIG. 3 illustrates the operation in one subfield selected from a plurality of subfields constituting one field when a selective write addressing method is employed. A subfield includes a reset period for carrying out a reset step, an address period for carrying out an address step, and a sustain period for carrying out a sustain step.

The reset period includes a first reset step RS1, a second reset step RS2, and a third reset step RS3.

First, in the first reset step RS1, the switching element S6 of the Y-sustain driver 11 is turned on, while the other switching elements of the Y-sustain driver 11 are turned off. At this time, the switching element S21 of the scan driver 12 is turned off, while the switching element S22 is turned on. The X-sustain driver 13 maintains the switching element S17 in on-state during the first reset step RS1. Therefore, an electric current flows from the positive terminal of the power source B7 through the switching element S17 and the resistor R4 to the row electrode Xⱼ. The current then flows between the row electrodes Xⱼ and Yⱼ, and further flows from the electrode Yⱼ through the switching element S22, the resistor R1, and the switching element S6 to the negative terminal of the power source B2. Since the row electrodes Xⱼ and Yⱼ and the space therebetween act as a capacitor, the potential at the row electrode Xⱼ gradually increases in the positive direction to Vrx to generate a reset pulse RPx, and the potential at the row electrode Yⱼ gradually decreases in the negative direction to −Vry to generate a first reset pulse RPy1. A reset discharge is generated between the row electrodes Xⱼ and Yⱼ through the simultaneous application of the negative polarity reset pulse RPy1 and the positive polarity reset pulse RPx. After the disappearance of the reset discharge, a negative polarity charge is formed on a dielectric layer of the display cell around the row electrode Xⱼ, and a positive polarity charge is formed on a dielectric layer of the display cell around the row electrode Yⱼ. Therefore, a so-called “wall charge state” is attained, in which the charge having different polarity is formed around the row electrodes Xⱼ and Yⱼ. After the levels of the reset pulses RPy1 and RPx are saturated, the switching elements S6 and S17 are turned off. At the same time when these switches are turned off, the switching elements S4, S5, S14, and S15 are turned on, and thus the row electrodes Xⱼ and Yⱼ are connected to the ground, resulting in the disappearance of the reset pulses RPx and RPy1.

Subsequently, in the second reset step RS2, the state of the switching element S21 of the scan driver 12 is changed from off-state to on-state, and the state of the switching element S22 is changed from on-state to off-state. The output voltage Vh of the power source B4 is then applied to the row electrode Yⱼ through the switching element S21, thereby forming a second reset pulse RPy2. That is, the second reset pulse RPy2 having a positive polarity voltage Vh is applied to the row electrode Yⱼ. In response to the application of the second reset pulse RPy2, a discharge is generated between the row electrodes Xⱼ and Yⱼ. As a result, a positive polarity charge and a negative polarity charge are formed in the dielectric layer of the display cell around the row electrodes Xⱼ and Yⱼ, respectively, and thus the amount of the wall charge is adjusted to a desired amount through the discharge.

Subsequently, in the third reset step RS3, the switching elements S4, S5, S14, and S15 are turned off, and the switching elements S7 and S16 are turned on. At the same time, the switching element S21 of the scan driver 12 is turned off, and the switching element S22 is turned on. An electric current flows from the positive terminal of the power source B6 through the switching element S16 and the resistor R3 to the row electrode Xⱼ. The electric current flows between the row electrodes Xⱼ and Yⱼ, and further flows from the row electrode Yⱼ through the switching element S22, the resistor R2, and the switching element S7 to the negative terminal of the power source B3. The potential at the row electrode Xⱼ rapidly increases in the positive direction to Voff2. On the other hand, since the potential at the row electrode Yⱼ is affected by the charge accumulated between the row electrodes Xⱼ and Yⱼ generated by the reset pulse RPy2, the potential gradually decreases in the negative direction and finally reaches −Voff1, thereby generating a total erasing pulse EP. That is, the total erasing pulse EP rising gradually and having a negative polarity is applied to the row electrode Yⱼ. An erasing discharge is generated between the row electrodes Xⱼ and Yⱼ in response to the application of the total erasing pulse EP. After the disappearance of the discharge, a negative polarity charge is formed around the row electrode Xⱼ, and a positive polarity charge is formed around the row electrode Yⱼ, and a positive polarity charge is formed around the electrode Dᵢ. Thus, the charge of the same polarity remains around the row electrodes Xj and Yj, thereby obtaining a charge neutrality state or a wall charge disappeared state. After the potential of the total erasing pulse EP reaches the saturation level, the switching element S7 is turned off, and the switching element S8 is turned on. Also, the switching element S21 of the scan driver 12 is turned on and the switching element S22 is turned off. As a result, the power sources B4 and B3 are connected in series under reverse bias between the row electrode Yⱼ and the ground, and the potential at the row electrode Yⱼ is rapidly shifted from a negative polarity potential −Voff1 to a positive polarity potential (Vh−Voff1), resulting in the disappearance of the total erasing pulse EP. The reset period is completed when the above potential change at the row electrode Yⱼ is made, and the address period starts.

In the address period, the column electrode drive circuit 3 converts the pixel data based on an image signal for each pixel into pixel data pulses DP₁ to DPₙ each having a voltage value corresponding to the logical level of the pixel data, and sequentially applies the pixel data pulses to the column electrodes D₁ to Dₘ row by row. The pixel data pulse DPⱼ is applied to the electrode Dᵢ for the row electrode Yⱼ. The Y-sustain driver 12 sequentially applies scanning pulses SP having a negative voltage to the row electrodes Y₁ to Yₙ such that each of the scanning pulses synchronizes to the timing of each of the pixel data pulses DP₁ to DPₙ. The switching element S21 is turned off, and the switching element S22 is turned on in synchronization with the application of the pixel data pulse DPⱼ supplied from the column electrode drive circuit 3. As a result, the negative potential −Voff1 at the negative terminal of the power source B3 is applied to the row electrode Yⱼ through the switching elements S8 and S22. The potential at the row electrode Yⱼ is then shifted from a positive polarity potential (Vh−Voff1) as described above to a negative polarity potential −Voff1, resulting in a scanning pulse SP to be applied to the row electrode Yⱼ. Therefore, the amplitude of the scanning pulse SP is identical to the pulse voltage Vh of the above reset pulse RPy2. The switching element S21 is turned on, and the switching element S22 is turned off in synchronization with termination of the application of the pixel data pulse DPⱼ supplied from the column electrode drive circuit 3, and the potential Vh−Voff1 at the positive terminal of the power source B4 is applied to the row electrode Yⱼ through the switching element S21. Subsequently, the scanning pulse SP is applied, in the same manner as in the row electrode Yⱼ, to each of the row electrode Yⱼ₊₁ to Yₙ in this order in synchronization with each of the pixel data pulses DPⱼ₊₁ to DPₙ supplied from the column electrode drive circuit 3. In a display cell corresponding to the row electrode to which the scanning pulse SP is applied, a discharge is generated when the pixel data pulse having a positive voltage is applied simultaneously with the scanning pulse SP, and the amount of the wall charge in the display cell increases such that discharge is triggered by the application of a sustain pulse. On the other hand, in a display cell to which the scanning pulse SP is applied but the pixel data pulse having a positive voltage is not applied, discharge is not triggered, and the amount of the wall charge does not increase. As a result, the display cells having increased wall charge serve as a light-emission display cell, and the display cells having unchanged wall charge serve as a non-emission display cell.

In the sustain period, the switching elements S8, S16, and S21 are turned off, while the switching elements S4, S5, S14, S15, and S22 are turned on. The potential at the row electrode Yⱼ becomes the ground potential (almost zero potential) through the on-state of the switching elements S4 and S5 of the Y-sustain driver 11 and the on-state of the switching element S22 of the scan driver 12. In the X-sustain driver 13, the potential at the row electrode Xⱼ becomes the ground potential (almost zero potential) through the on-state of the switching elements S14 and S15. Subsequently, the switching element S4 is turned off, and the switching element S1 is turned on. At this time, an electric current generated by charge accumulated in the capacitor C1 flows to the row electrode Yⱼ through the coil L1, the switching element S1, the diode D1, the switching element S5, and the switching element S22. The current passes through a capacitor component between the row electrodes Yⱼ and Xⱼ, and further flows to the ground through the switching elements S15 and S14. Therefore, the capacitor component between the row electrodes Yⱼ and Xⱼ is charged. At this time, the potential at the row electrode Yⱼ gradually increases in magnitude as illustrated in FIG. 3, depending on the time constant of the coil L1 and the capacitor component between the row electrodes Yⱼ and Xⱼ. Subsequently, the switching element S3 is turned on, and the potential Vs from the positive terminal of the power source B1 is applied to the row electrode Yⱼ. Immediately after this, the switching element S1 is turned off. The switching element S3 is held on for a predetermined period of time. After this period, the switching element S3 is turned off, and, at the same time, the switching element S2 is turned on. As a result, an electric current generated by the charge accumulated in the capacitor component between the row electrodes Yⱼ and Xⱼ flows from the row electrode Yⱼ to the capacitor C1 through the switching elements S22, S5, the coil L2, the diode D2, and the switching element S2. At this time, the potential at the row electrode Yⱼ gradually decreases in magnitude as illustrated in FIG. 3, which is determined by the time constant of the coil L2 and the capacitor C1. When the potential at the row electrode Yⱼ becomes almost 0 V, the switching element S2 is turned off, and the switching element S4 is turned on. A sustain pulse IPy having a positive polarity pulse voltage Vs illustrated in FIG. 3 is applied to the row electrode Yⱼ through the operation of the Y-sustain driver 11 described above. After the sustain pulse IPy disappears, in the X-sustain driver 13, the switching element S11 is turned on, and the switching element S14 is turned off. Although the potential at the row electrode Xⱼ was nearly 0 V (the ground potential) when the switching element S14 was turned on, upon turning off the switching element S14 and turning on the switching element S11, an electric current generated by charge accumulated in the capacitor C2 flows to the row electrode Xⱼ through the coil L3, the switching element S11, the diode D3, and the switching element S15. The current passes through a capacitor component between the row electrodes Xⱼ and Yⱼ, and further flows to the ground through the switching elements S22, S5, and S4. Therefore, the capacitor component between the row electrodes Yⱼ and Xⱼ is charged. At this time, the potential at the row electrode Xⱼ gradually increases in magnitude as illustrated in FIG. 3, depending on the time constant of the coil L3 and the capacitor component between the row electrodes Xⱼ and Yⱼ. Subsequently, the switching element S13 is turned on, and the potential Vs from the positive terminal of the power source B5 is applied to the row electrode X1. Immediately after this, the switching element S11 is turned off. The switching element S13 is held on for a predetermined period of time. After this period, the switching element S13 is turned off, and, at the same time, the switching element S12 is turned on. As a result, an electric current generated by charge accumulated in the capacitor component between the row electrodes X₁ and Yⱼ flows from the row electrode X1 to the capacitor C2 through the switching element S15, the coil L4, the diode D4, and the switching element S12. At this time, the potential at the row electrode X1 gradually decreases in magnitude as illustrated in FIG. 3, depending on the time constant of the coil L4 and the capacitor C2. When the potential at the row electrode X1 becomes almost 0 V, the switching element S12 is turned off, and the switching element S14 is turned on. A sustain pulse IPx having a positive polarity pulse voltage Vs illustrated in FIG. 3 is applied to the row electrode Xⱼ through the operation of the X-sustain driver 13 described above. In the rest of the sustain period after the application of the sustain pulse IPx to the row electrode Xⱼ, the sustain pulses IPy and IPx are alternately generated and alternately applied to the row electrodes Yⱼ and Xⱼ, respectively. Every time the sustain pulse IPy or IPx is applied, a sustain discharge is triggered in the display cell in which the wall charge has been formed, and the light emission state in response to the discharges is maintained. The sustain pulse IPx is applied at an application timing not only to the row electrode Xⱼ but also to all of the row electrodes X₁ to Xₙ simultaneously. Also, the sustain pulse IPy is applied at an application timing not only to the row electrode Yⱼ but also to all of the row electrodes Y₁ to Yₙ simultaneously.

Meanwhile, the pulse voltage Vh of the second reset pulse RPy2, which is applied to the row electrode Y in the second reset step RS2 for adjusting the amount of the wall charge formed in each of the display cells in the above first reset step RS1, is smaller than the pulse voltage Vs of the above sustain pulses IPy and IPx.

Therefore, the discharge generated by the application of the second reset pulse RPy2 is weaker than the sustain discharge generated by the application of the sustain pulses IPy and IPx, and the light emission luminance in response to the discharge generated by the application of the second reset pulse RPy2 is also lower. As a result, the light emission luminance responding to the discharge generated for adjusting the amount of wall charge during a reset period (this discharge is not related to a display image) is lowered, thereby enhancing the contrast of an image.

In the Y-sustain deriver 11 illustrated in FIG. 2, both of the total erasing pulse EP and the scanning pulse SP illustrated in FIG. 3 are triggered by the application of the voltage Voff1 supplied from the power source B3. When the voltage Voff1 is changed in order to change the pulse voltage of the scanning pulse SP, the pulse voltage of the total erasing pulse EP is also changed according to the change made to Voff1 so that erroneous discharge at addressing may be prevented.

In the embodiment described above, the driving operation according to the selective write addressing method during the reset period, the address period, and the sustain period has been explained referring to FIG. 3 as an example, no limitation thereto intended in the present invention. In fact, the invention is also applicable to driving operation employing a so called “selective erase addressing method” in which wall charge is formed in all display cells in advance (in a reset period) and the wall charge formed in each of the display cells are selectively erased according to a pixel data (in an address period).

It is understood that the foregoing description and accompanying drawings set forth the preferred embodiments of the invention at the present time. Various modifications, additions, and alternatives will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese Patent Application No. 2004-83107 which is hereby incorporated by reference.

1. A method of driving a display panel in which display cells serving as pixels are formed at intersections of pairs of row electrodes corresponding to respective display lines with a plurality of column electrodes being arranged so as to intersect with the pairs of row electrodes, said method comprising the steps of:
resetting by initializing the amount of wall charge in each of the display cells;
selectively generating an address discharge in the display cells by applying a data pulse corresponding to an input image signal to each of the column electrodes while applying a scanning pulse to one row electrode of the pair of row electrodes to thereby form or erase the wall charge; and
generating a sustain discharge only in the display cells in which the wall charge is formed, by applying sustain pulses alternately to one and the other row electrodes of the pair of row electrodes,
wherein said step of resetting includes the steps of:
triggering a first reset discharge between one and the other row electrodes of the pair of row electrodes by applying a first reset pulse having a voltage increasing in magnitude with time to the row electrodes to thereby form the wall charge, and
triggering a second reset discharge between one and the other row electrodes of the pair of row electrodes by applying a second reset pulse having a pulse voltage lower in magnitude than that of the sustain pulse to the row electrodes to thereby adjust the amount of the wall charge.

2. A method for driving a display panel according to claim 1, wherein an amplitude of the scanning pulse is identical to a pulse voltage of the second reset pulse.
